(19) United States
(12) Patent Application Publication
(10) Pub. No.: US 2005/0264701 A1
(43) Pub. Date: Dec. 1, 2005

(54) Method and system for color temperature conversion of compressed video image

(76) Inventors: Young-Sik Huh, Kyungki-do (KR); Ki-Won Yoo, Seoul (KR); Du-Sik Park, Kyungki-do (KR)

Correspondence Address: STEIN, MCEWEN & BUI, LLP, 1400 EYE STREET, NW, SUITE 300, WASHINGTON, DC, 20005, US

(21) Appl. No.: 10/520,168

(22) PCT Filed: Jul. 3, 2003
(86) PCT No.: PCT/KR03/01305

§ 371 Date: Jan. 4, 2005

(30) Foreign Application Priority Data
Jul. 4, 2002 (KR) 10-2002-0038659

(51) Int. Cl. H04N 9/73

(52) U.S. Cl. 348/655; 375/240.02

(57) ABSTRACT

A system to estimate and change a color temperature of a compressed video image and change includes a color temperature estimation unit to receive a video image compressed using block-based discrete cosine transformation, generate a discrete cosine (DC) video image corresponding to the compressed video image, and estimates the color temperature of the compressed video image using the DC video image; a decoder to decode the compressed video image to generate an original video image; and a color temperature change unit to determine the estimated color temperature of the compressed video image or a color temperature of the decoded original video image as an application color temperature according to whether the compressed video image is a moving video image, and changes the color temperature of the decoded original video image in accordance with the application color temperature and a color temperature preferred by a user.

### BACKGROUND OF THE INVENTION

This application claims the benefit of Korean Patent Application No. 10-2002-0038659, filed on Jul. 4, 2002, in the Korean Intellectual Property Office, the disclosure of which is incorporated herein in its entirety by reference.

1. Field of the Invention

The present invention relates to a method and system for changing a color temperature of a display device, and more particularly, to a method and system for estimating a color temperature of a compressed video image and changing the color temperature of the compressed video image in accordance with a user's preference.

2. Description of the Related Art

The concept of a color temperature refers to the temperature to which a black body radiator, such as graphite, has to be heated to produce light of special spectral characteristics. In image processing, the color temperature is used to quantify the degree of warmness and coldness felt by a user watching a video image. The color temperature is indicated in Kelvin degrees, which are equal to 273 degrees plus degrees Celsius. The color temperature of a video image is defined as the value at which the chromaticity coordinates of the video image match those of a light source.

In general, a video image having a high color temperature shows an overall bluish light, and a video image having a low color temperature shows an overall reddish light, different in general from the color temperature preferred by a user.

As disclosed in U.S. Pat. Nos. 4,562,460, 4,633,299, and 4,788,586, in order to change a color temperature of a video image according to a user's preference, a TV or monitor includes a control button that varies the amount of hue or RGB, so that the user can directly adjust the color temperature of a certain video image or scene to a desirable color temperature using the control button.

However, there are many inconveniences when controlling a color temperature of a moving video image showing other various contents. In addition, methods for changing a color in the above manner make a video image appear less natural as if the video image has passed through a specific color filter.

As another method for changing a color temperature of a compressed video image, U.S. Pat. No. 6,172,719 discloses a method for sensing environmental brightness and color of a video appliance by using a chromaticity sensing section and for automatically changing a color temperature of the video appliance. In the method, the color temperature of the video appliance is changed based on characteristics of environment regardless of the characteristics of a video image itself. Thus, the method is appropriate for viewer mood control based on the background of a video image, but does not allow for a color temperature change based on color temperatures of contents of the video image. In general, an environment where a video image display device, such as a TV or a monitor, is used is not changed frequently. On the other hand, the contents of a video image change quite often. Thus, a color temperature of a video image has to be changed in accordance with a change in the contents of the video image in consideration of a user's preference.

To solve this problem, U.S. Pat. Nos. 4,685,071 and 5,495,428 and Korean Patent Application No. 1998-53119 disclose a method for estimating a color temperature (illuminant color) of a video image. A method for collectively changing a color temperature of a video image to a color temperature preferred by a user, using a determined color temperature is disclosed in Korean Patent Application No. 1999-50596.

However, in all the above methods, a color temperature estimation process is performed using a matrix multiplication operation with respect to each pixel. Thus, the methods are characterized by considerable computational loads, owing to the matrix multiplication operation in a user terminal, which lower the quality of an output video image and require additional costs for performance improvement. Further, when a video image whose color temperature is to be changed is a compressed moving video image, the compressed moving video image should be completely decoded. This decoding operation adds to the overall computational load, thereby increasing the response time of devices using these methods.

### SUMMARY OF THE INVENTION

The present invention provides a method and system for changing a color temperature of a compressed video image which, in a case of a video image compressed using block-based discrete cosine transformation (DCT), for example, an MPEG compressed moving video image, can reduce the number of pixels to be processed during a color temperature estimation process, and improve the processing speed of the color temperature estimation process by estimating a color temperature from a DC video image obtained from DC components of the compressed video image, instead of using a video image obtained by completely decoding the compressed video image during the color temperature estimation process.

The present invention also provides a method and system for changing a color temperature of a compressed video image which can improve the overall processing speed of a color temperature change process by improving the processing speed of the color temperature estimation process.

According to one aspect of the present invention, a system for estimating a color temperature of a compressed video image and changing the color temperature of the compressed video image includes a color temperature estimation unit, which receives a video image compressed using block-based discrete cosine transformation, generates a DC video image corresponding to the compressed video image, and estimates a color temperature of the compressed video image using the DC video image; a decoder, which decodes the compressed video image to generate an original video image; and a color temperature change unit, which determines the estimated color temperature of the compressed video image or a color temperature of the decoded original video image as an application color temperature depending on whether the compressed video image is a moving video image, and changes the color temperature of the decoded original video image in accordance with the application color temperature and a color temperature preferred by a user.

It is preferable that the color temperature estimation unit includes a DC video image extraction section, which extracts DC coefficients of each block from the compressed video image, each DC coefficient representing an average value of pixel values of each block of video image, defines the DC coefficients as each pixel value, and generates a DC video image composed of the pixel values; and a color temperature estimation section, which estimates a color temperature of the entire compressed video image from the color temperature of the DC video image. It is also preferable that the color temperature change unit includes an application color temperature determination section, which determines the estimated color temperature of the compressed video image or the color temperature of the decoded video image as an application color temperature depending on whether the compressed video image is a moving video image; and a color temperature change section, which receives the color temperature preferred by the user and changes the color temperature of the decoded video image in accordance with the application color temperature and the color temperature preferred by the user.

According to another aspect of the present invention, a method for estimating a color temperature of a compressed video image and changing the color temperature of the compressed video image includes (a) receiving a video image compressed using block-based discrete cosine transformation, generating a DC video image corresponding to the compressed video image, and estimating a color temperature of the compressed video image using the DC video image; (b) decoding the compressed video image to generate an original video image; and (c) determining the estimated color temperature of the compressed video image or a color temperature of the decoded original video image as an application color temperature depending on whether the compressed video image is a moving video image, and changing the color temperature of the decoded original video image in accordance with the application color temperature and a color temperature preferred by a user.

It is preferable that step (a) includes (a1) extracting DC coefficients of each block from the compressed video image, each DC coefficient representing an average value of pixel values of each block of the video image, defining the DC coefficients as each pixel value, and generating a DC video image composed of the pixel values; and (a2) estimating a color temperature of the entire compressed video image from the color temperature of the DC video image. It is also preferable that step (c) includes (c1) determining the estimated color temperature of the compressed video image or the color temperature of the decoded original video image as an application color temperature depending on whether the compressed video image is a moving video image; and (c2) receiving the color temperature preferred by the user and changing the color temperature of the decoded original video image in accordance with the application color temperature and the color temperature preferred by the user.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram illustrating the structure of a system for changing a color temperature of a compressed video image, according to the present invention;

FIG. 2 is a flowchart illustrating a method for estimating a color temperature of a compressed video image and changing the color temperature of the compressed video image, according to the present invention;

FIG. 3A illustrates a compressed video image and an extracted DC video image, according to the present invention;

FIG. 3B illustrates a method for extracting a DC video image from a compressed video image that is interframe-coded, according to the present invention; and

FIG. 4 is a flowchart illustrating a method for determining an application color temperature of a compressed video image, according to the present invention.

### DETAILED DESCRIPTION OF THE INVENTION

Hereinafter, the present invention will be described in detail by describing preferred embodiments of the invention with reference to the accompanying drawings.

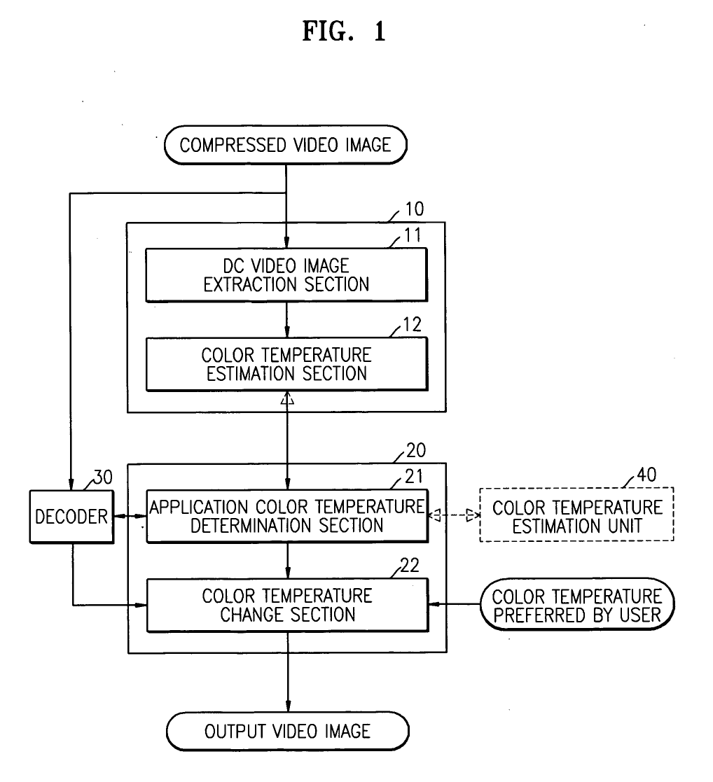

FIG. 1 is a block diagram illustrating the structure of a system for changing a color temperature of a compressed video image according to the present invention.

The system for changing a color temperature of a compressed video image according to the present invention includes a color temperature estimation unit 10 which estimates a color temperature of an input compressed video image, a decoder 30 which decodes the input compressed video image, and a color temperature change unit 20 which changes a color temperature of the decoded video image in accordance with an input color temperature preferred by a user.

In addition, the color temperature estimation unit 10 includes a DC video image extraction section 11 which extracts a DC video image from the input compressed video image and a color temperature estimation section 12 which estimates a color temperature of the entire compressed video image from the DC video image.

In addition, the color temperature change unit-20 includes an application color temperature determination section 21 which determines whether the input compressed video image is a still video image or a moving video image and determines an application color temperature to be used for color temperature change from the estimated color temperature, and a color temperature change section 22 which changes a color temperature of the decoded input compressed video image in accordance with the application color temperature and the color temperature preferred by the user.

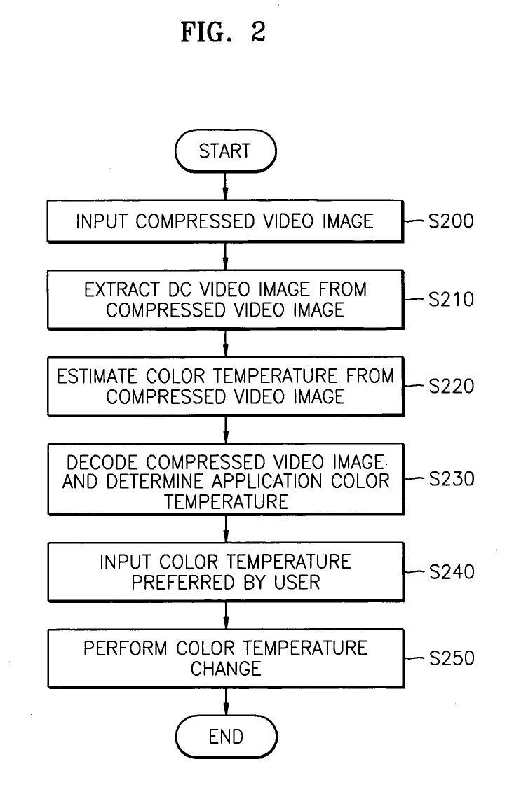

Hereinafter, a method for estimating a color temperature of a compressed video image and changing the color temperature of the compressed video image will be described with reference to FIGS. 1 and 2.

FIG. 2 is a flowchart illustrating a method for estimating a color temperature of a compressed video image and changing the color temperature of the compressed video image, according to the present invention.

As shown in FIG. 1, the compressed video image is input into the DC video image extraction section 11 and the decoder 30. The term “compressed video image” refers to a still video image or moving video image compressed using block-based discrete cosine transformation (DCT), such as an MPEG 1, 2, or 4 image (S200).

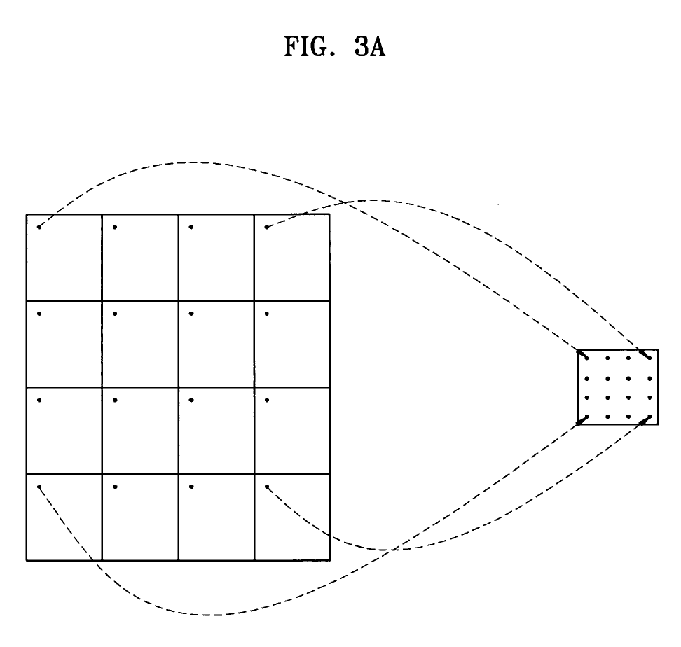

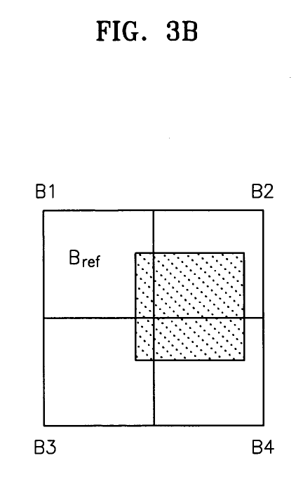

When the input compressed video image is a still video image or an internally-coded moving video image, the DC video image extraction section 11 generates a DC video image from the input compressed video image by setting a DC coefficient obtained by multiplexing a DCT coefficient with respect to coordinates (0,0) of DCT blocks of the input compressed video image by a constant (preferably, ⅛) to one pixel value. The DCT coefficient with respect to coordinates (0,0) of DCT blocks represents an average value of pixel values of an original video image which corresponds to its DCT block. Thus, an average value of the entire pixel values of one DCT block can be obtained using only one coordinate value. Accordingly, when the input compressed video image is composed of DCT blocks each block having N×N pixels, the extracted DC video image has a number of pixels equal to 1/N² times the number of pixels of the decoded video image. This will be described in detail with reference to FIG. 3A.

For brief explanation, assuming that the compressed video image shown on a left side of FIG. 3A is composed of 16 DCT blocks, if DCT coefficients with respect to coordinates (0,0) of each of 16 DCT blocks are multiplied by a predetermined constant and mapped to one DC video image, a video image shown on the right side of FIG. 3A is extracted as one DC video image having a 4×4 size, that is, 16 pixel values. Consequently, a color temperature of the entire video image can be estimated from a reduced DC video image having a number of pixels equal to 1/N² times the number of pixels of the original video image.

Only if a corresponding DCT block is internally-coded like in an MPEG intraframe, a value corresponding to coordinates (0,0) of each DCT block is taken without changes. However, if the corresponding DCT block is interframe-coded, a value estimated from DCT blocks referred by a DCT block whose DC coefficients of a present frame are to be extracted can be taken as a pixel value of a DC video image.

A method for extracting the DC video image from the interframe-coded compressed video image will be described with reference to FIG. 3B.

First, assuming that a present frame is coded by referring to a previous frame, when a video image corresponding to a DCT block whose DC coefficients are to be extracted is exactly coincident with a video image corresponding to one DCT block of the previous frame, a DCT coefficient with respect to coordinates (0,0) of a DCT block of the previous frame is used without changes. However, when the video image corresponding to the DCT block whose DC coefficients are to be extracted exists over a plurality of DCT blocks of the previous frame, the DC coefficients are determined in accordance with the ratio of the area where the video image corresponding to the DCT block whose DC coefficients of the present frame are to be extracted to the area of previous DCT blocks. In other words, when the video image corresponding to the DCT block B_{ref} whose DC coefficients of the present frame are to be extracted exists over four DCT blocks B1, B2, B3, and B4 of the previous frame, the ratio of the area occupied by DCT blocks in which the present frame is referred is expressed as Wᵢ=(the area of B_{ref} ∩Bᵢ)/(the area of Bᵢ), and DC coefficients of Bᵢ are expressed as DCᵢ(i=1, 2, 3, 4), DC coefficients of the DCT block B_{ref} are expressed as

$${DC}_{ref} = {\sum }_{i = 1}^{4} {W}_{i} \times {DC}_{i} .$$

The generated DC video image is input into the color temperature estimation section 12, and the color temperature estimation section 12 estimates a color temperature from the generated DC video image (S220). Since there is no large difference between the input DC video image and a general video image excluding that the size of a video image is greatly reduced, color temperature estimation can be performed by a general estimating method of color temperature of the generated video image.

After the generated DC video image is input into the color temperature estimation section 12, highlighted regions are extracted from the input video image. Each of the extracted highlighted regions is projected onto chromaticity plane, geometric expression parameters on a corresponding shape on the chromaticity plane are calculated, and an average value of the input DC video image is calculated. The average value of the DC video image is multiplied by a predetermined coefficient and set to a self-luminous threshold value, a self-luminous region having a chromaticity coordinate value exceeding the self-luminous threshold value is removed from the DC video image, and an illuminant color using a recognition light source method is estimated from the average value of the DC video image from which the self-luminous region is removed. A predetermined number of geometric expression parameters located around the estimated illuminant color are selected, and a final color temperature is estimated using the selected geometric expression parameters.

After the color temperature estimated from the DC video image is input into the adaptive color temperature change unit 20, the application color temperature determination section 21 determines whether the estimated color temperature is used for color temperature change of the compressed video image. The decoder 30 decodes a corresponding frame of the compressed video image (S230).

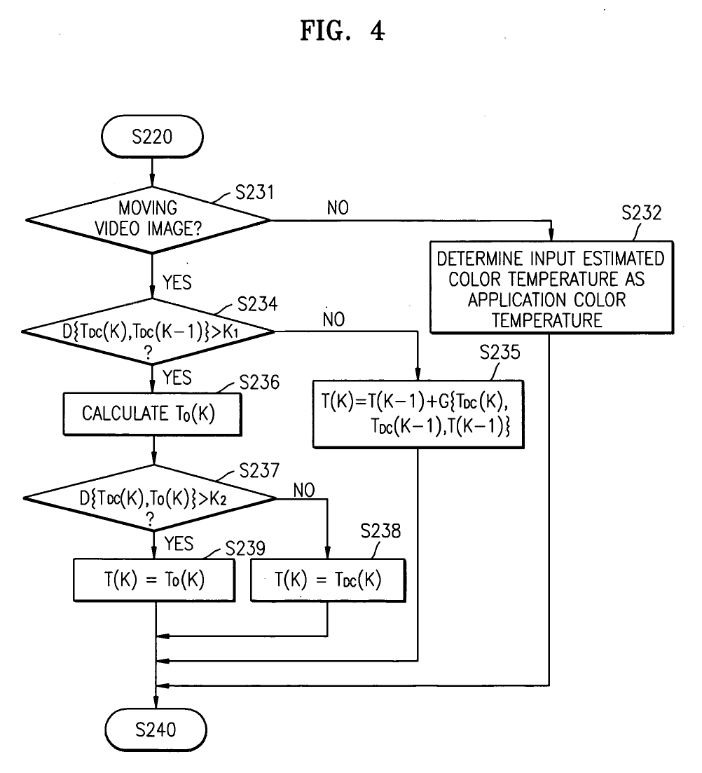

A method for determining an application color temperature of the compressed video image will be described in detail with reference to FIG. 4.

The application color temperature determination section 21 receives a compressed video image from the decoder 30 and determines whether the compressed video image whose color temperature is to be changed is a moving video image (S231). When the compressed video image is a single still video image, the application color temperature determination section 21 determines an estimated color temperature of the input DC video image as an application color temperature (S232).

Meanwhile, when the compressed video image is a moving video image, a difference between an estimated color temperature T_{DC}(k) of the DC video image of a present video image frame (k-th frame) and an estimated color temperature T_{DC}(k-1) of the DC video image of a previous frame is calculated, and the difference is compared with a first critical value k1 (S234).

Since similar scenes are continuously displayed in each frame of a moving video image, a color temperature having similar values each other with respect to each frame of a video image should be maintained although there is a little difference therebetween. Thus, a color temperature difference which does not make the user feel uncomfortable when watching a video image is set to a first critical value k1 (200° K in a preferred embodiment of the present invention). If the difference between the estimated color temperature T_{DC}(k) of the DC video image of the present video image frame and the estimated color temperature T_{DC}(k-1) of the DC video image of the previous frame is smaller than the first critical value k1, an application color temperature value Tk of the present frame is calculated by adding a predetermined correction function value to an application color temperature value T(k-1) of the previous frame (S235).

A difference between color temperature values which is compared with a critical value is obtained using a color temperature difference measure function D(t1, t2). D(t1, t2) is a color temperature difference measure function that determines a difference between two color temperatures t1 and t2. After color temperature regions are changed using a reverse scale, such as 10⁶/T, D(t1, t2) can be defined by a difference therebetween. Accordingly, according to an embodiment of the present invention, D(t1, t2) is defined as D(t1, t2)=|10⁶/t1−10⁶/t2| and can be defined by a difference between quantized sections after change regions are quantized after reverse scale change.

The reason a color temperature difference is defined through reverse scaling is that, even though a difference between two color temperatures t1 and t2 in one of a high color temperature region and in a low color temperature region is the same, a user's feeling of this difference is not the same. In other words, even though the difference between two color temperatures t1 and t2 is, for example, 200° K, the user feels the color temperature difference between video images having a color temperature of 800° K and 1000° K, respectively, much stronger than in the case of the color temperature difference between video images having a color temperature of 1800° K and 2000° K, respectively.

As such, the color temperature measure function is used as described above, instead of using |T_{DC}(k)-T_{DC}(k-1)| as a color temperature difference. Besides, D(t1, t2) can be defined through other scalings, such as linear scaling, nonlinear scaling, continuous scaling, or noncontinuous scaling.

As described above, if the difference between the estimated color temperature T_{DC}(k) of the DC video image of the present frame and the estimated color temperature T_{DC}(k-1) of the DC video image of the previous frame is not larger than the first critical value k1, the application color temperature value T(k) of the present frame is calculated by adding a predetermined correction function value to the application color temperature value T(k-1) of the previous frame. When the predetermined correction function is g(t₁, t₂, t₃), the application color temperature T(k) of the present frame is determined as shown in Equation 1.
T(k)=T(k−1)+g(T_{DC}(k),T_{DC}(k−1),T(k−1)) (1)

Here, the correction function g(t₁, t₂, t₃) varies depending on color temperatures t₁, t₂, and t₃, and a color temperature difference measure function and can be simply defined as g(t₁, t₂, t₃)=t₁-t₂ (S235).

Meanwhile, if the difference between the estimated color temperature T_{DC}(k) of the DC video image of the present frame and the estimated color temperature T_{DC}(k-1) of the DC video image of the previous frame is larger than the first critical value k1, a decoded original video image of the present frame is received from the decoder 30 and output to the color temperature estimation section 12 of the color temperature estimation unit 10 or to a separate color temperature estimation section 40 or to the color temperature estimation section 40 of the adaptive color temperature change unit 20. The color temperature estimation section 12 or 40 which receives the decoded original video image of the present frame, estimates a color temperature of the decoded original video image using the same method as the method used to estimate a color temperature from the above-mentioned DC video image and outputs an estimated color temperature Tₒ(k) of the decoded original video image to the application color temperature determination section 21 (S236).

The application color temperature determination section 21 obtains a color temperature difference D(T_{DC}(k), Tₒ(k)) by applying the estimated color temperature Tₒ(k) of the received decoded video image and the estimated color temperature T_{DC} of the DC video image of the present frame to the color temperature difference measure function. Thereafter, the application color temperature determination section 21 compares the color temperature difference D(T_{DC}(k), Tₒ(k)) with a second critical value k2 (200° K in a preferred embodiment of the present invention) set to a color temperature difference that does not make the user feel uncomfortable when watching a video image (S237).

As a comparison result, if the color temperature difference is not larger than the second critical value k2, there is a difference of more than the first critical value k1 between the color temperature estimated from the DC video image of the present frame and the estimated color temperature of the DC video image of the previous frame. However, since there is no large difference in how the user perceives the video image in comparison with a color temperature of the original video image, the estimated color temperature T_{DC}(k) of the DC video image of the present frame is determined as the application color temperature T(k) of the present frame (S238).

Meanwhile, if the color temperature difference is larger than the second critical value k2, since a difference between the color temperature estimated from the DC video image of the present frame and the estimated color temperature of the DC video image of the previous frame is unacceptable, the application color temperature T(k) of the present frame is determined as the estimated color temperature Tₒ(k) of the decoded video image (S239).

If the present frame is a first frame of a moving video image or a frame whose estimated color temperature of the DC video image of the previous frame cannot be known owing to network or system conditions, an application color temperature is determined by performing process S236.

The application color temperature determined by the application color temperature determination section 21 is input into the color temperature change section 22, and a color temperature preferred by the user is input into the color temperature change section 22 (S240). The color temperature preferred by the user may be input using a terminal, or selected by the user after a video image display device presents a video image of a variety of colors, or be determined in accordance with a past color temperature preference value that has been selected by the user on an existing video image.

The color temperature change section 22 into which the application color temperature and the color temperature preferred by the user are input, performs color temperature change from the application color temperature into the color temperature preferred by the user on the decoded and input original video image of each frame (S250).

A method for changing a color temperature of a compressed video image to which the present invention can be applied is as follows. A color temperature used in a general TV or monitor is set to a reference color temperature. When a color temperature preferred by a user is input, the reference color temperature is changed into the color temperature preferred by the user. When the change is performed using a predetermined mapping method, a target color temperature Tₜ of an output video image in which an application color temperature Tᵢ of each frame is changed in accordance with the mapping method is obtained, the target color temperature Tₜ and the application color temperature are changed into CIE XYZ tristimulus vectors, and a conversion matrix M between the two changed tristimulus vectors is obtained. A RGB value (Rᵢ, Gᵢ, Bᵢ) of each pixel of an input video image frame is changed into linear RGB, changed into CIE XYZ vectors, and the conversion matrix M is applied to the changed CIE XYZ vectors. CIE XYZ vectors obtained by applying the conversion matrix M are changed into linear RGB, an the linear RGB is changed into its original RGB, so that a video image whose color temperature is changed is output.

The present invention can also be embodied as a computer readable code on a computer readable recording media. The computer readable recording media include all types of recording devices in which data that can be read by a computer system are stored, such as ROMs, RAMs, CD-ROMs, magnetic tapes, floppy discs, optical data storage units, and carrier waves (for example, transmission via the Internet). Also, the computer readable recording media are distributed over a network-connected computer system and can be stored and executed by computer readable codes.

In particular, in preferred embodiments of the present invention, the color temperature preferred by the user is input into the color temperature change section 22 after the application color temperature is determined. However, it is obvious to those skilled in the art that the objects of the present invention can be achieved even though the application color temperature is determined after the color temperature preferred by the user is input into the color temperature change section 22.

As described above, in a method and system for changing a color temperate of a compressed video image according to the present invention, by estimating the color temperature from a DC video image obtained from DC components of the compressed video image, instead of using a video image obtained by completely decoding the compressed video image, and omitting a process of completely decoding the compressed video image, the number of pixels used during the color temperature estimation process is greatly reduced, and the processing speed of the color temperature estimation process and the overall processing speed of a color temperature change process are improved. In addition, by using an adaptive method when color temperature change is performed using a color temperature estimated from the DC video image, an error in the color temperature change caused by a difference between the color temperature estimated from the DC video image and the color temperature estimated from the original video image is reduced.

The method and system for changing the color temperature of the compressed video image according to the present invention can be used in all industrial fields where a variety of digital video image contents are stored in, transmitted to, and reproduced in the user terminal.

While this invention has been particularly shown and described with reference to preferred embodiments thereof, it will be understood by those skilled in the art that various changes in form and details may be made therein without departing from the spirit and scope of the invention as defined by the appended claims.

1. A system to estimate a color temperature of a compressed video image and change the color temperature of the compressed video image, the system comprising:
a color temperature estimation unit to receive a video image compressed using a block-based discrete cosine transformation (DCT), generates a discrete cosine (DC) video image corresponding to the compressed video image, and estimates the color temperature of the compressed video image using the DC video image;
a decoder to decode the compressed video image to generate an original video image; and
a color temperature change unit to determine the estimated color temperature of the compressed video image or a color temperature of the decoded original video image as an application color temperature according to whether the compressed video image is a moving video image, and changes the color temperature of the decoded original video image in accordance with the application color temperature and a color temperature preferred by a user.

2. The system of claim 1, wherein the color temperature estimation unit comprises:
a DC video image extraction section to extract DC coefficients of each of a plurality of (DCT) blocks from the compressed video image, each of the DC coefficients representing an average value of pixel values of each of the respective DCT blocks of the compressed video image, defines the DC coefficients as average pixel values, and generates a DC video image composed of the average pixel values; and
a color temperature estimation section to estimate a color temperature of the entire compressed video image from the color temperature of the DC video image.

3. The system of claim 2, wherein the DC coefficients of each of the DCT blocks are obtained by multiplying DCT coefficients with respect to coordinates (0,0) of each of the DCT blocks by a predetermined constant in response to the compressed video image being a still video or an internally coded moving video image.

4. The system of claim 2, wherein the DC coefficients of each of the DCT blocks of a current frame are calculated as a sum of terms corresponding to four blocks of a previous frame in response to the compressed video image being an interframe-coded moving video image; and
wherein each of the terms is determined as a product of a ratio of an overlapping area of a DCT block whose DC coefficients of the current frame are to be extracted and DCT blocks of a previous frame to the area of the DCT blocks of the previous frame and DC coefficients of each DCT block of the previous frame.

5. The system of claim 1, wherein the color temperature change unit comprises:
an application color temperature determination section to determine the estimated color temperature of the compressed video image or the color temperature of the decoded video image as the application color temperature according to whether the compressed video image is a moving video image; and
a color temperature change section to receives the color temperature preferred by the user and changes the color temperature of the decoded video image in accordance with the application color temperature and the color temperature preferred by the user.

6. The system of claim 5, wherein the application color temperature determination section compares a first color temperature difference between an estimated color temperature of the DC video image of a current frame and an estimated color temperature of the DC video image of a previous frame with a first predetermined critical value in response to the compressed video image being interframe coded; and
determines the application color temperature of the current frame by adding a correction function to the application color temperature of the previous frame.

7. The system of claim 5, wherein the application color temperature determination section compares a first color temperature difference between an estimated color temperature of the DC video image of a current frame and an estimated color temperature of the DC video image of a previous frame with a first predetermined critical value in response to the compressed video image being interframe coded;
receives the decoded current frame from the decoder, estimates the color temperature from the decoded current frame, calculates a second color temperature difference between the estimated color temperature of the DC video image of the current frame and the estimated color temperature of the decoded current frame, and compares the second color temperature difference with a predetermined second critical value in response to the first color temperature difference being larger than the first critical value; and
determines the estimated color temperature of the DC video image of the current frame as the application color temperature of the current frame in response to the second color temperature difference being less than the second critical value.

8. The system of claim 5, wherein the application color temperature determination section compares a first color temperature difference between an estimated color temperature of the DC video image of a current frame and an estimated color temperature of the DC video image of a previous frame with a first predetermined critical value in response to the compressed video image being interframe coded; and
receives the decoded current frame from the decoder, estimates the color temperature from the decoded current frame, calculates a second color temperature difference between the estimated color temperature of the DC video image of the current frame and the estimated color temperature of the decoded current frame, and compares the second color temperature difference with a predetermined second critical value in response to the first color temperature difference being larger than the first critical value; and
determines the estimated color temperature of the DC video image of the decoded current frame as the application color temperature of the current frame in response to the second color temperature difference being larger than the second critical value.

9. The system of claim 6, wherein the first color temperature difference between the estimated color temperature of the DC video image of the current frame and the estimated color temperature of the DC video image of the previous frame and the second color temperature difference between the estimated color temperature of the DC video image of the current frame and the estimated color temperature of the decoded current frame are differences between values obtained by multiplying inverse numbers of each color temperature by a predetermined coefficient.

10. The system of claim 6, wherein the first and second critical values are approximately 200° K.

11. A method off estimating a color temperature of a compressed video image and changing the color temperature of the compressed video image, the method comprising:
receiving a video image compressed using a block-based discrete cosine transformation (DCT), generating a discrete cosine (DC) video image corresponding to the compressed video image, and estimating the color temperature of the compressed video image using the DC video image;
decoding the compressed video image to generate an original video image; and
determining the estimated color temperature of the compressed video image or a color temperature of the decoded original video image as an application color temperature according to whether the compressed video image is a moving video image, and changing the color temperature of the decoded original video image in accordance with the application color temperature and a color temperature preferred by a user.

12. The method of claim 11, wherein the generating the DC video image and estimating the color temperature of the compressed video image using the DC video image comprises:
extracting DC coefficients of each of a plurality of DCT blocks from the compressed video image, each of the DC coefficients representing an average value of pixel values of each of the respective DCT blocks of the compressed video image, defining the DC coefficients as average pixel values, and generating a DC video image composed of the average pixel values; and
estimating a color temperature of the entire compressed video image from the color temperature of the DC video image.

13. The method of claim 12, wherein the extracting and defining the DC coefficients and generating the DC video image comprises:
obtaining the DC coefficients of each of the DCT blocks by multiplying DCT coefficients with respect to coordinates (0,0) of each of the DCT blocks by a predetermined constant in response to the compressed video image being a still video image or an internally coded moving video image;
defining the DC coefficients of each of the DCT blocks as the average pixel values; and
generating the DC video image composed of the average pixel values.

14. The method of claim 12, wherein the extracting and defining the DC coefficients and generating the DC video image comprises:
calculating the DC coefficients of each of the DCT blocks of a current frame as a sum of terms corresponding to four blocks of a previous frame in response to the compressed video image being an interframe coded moving video image, wherein each of the terms is determined as a product of a ratio of an overlapping area of a DCT block whose DC coefficients of the current frame are to be extracted and DCT blocks of a previous frame to the area of the DCT blocks of the previous frame and DC coefficients of each DCT block of the previous frames;
defining the DC coefficients as the average pixel values, and
generating the DC video image composed of the average pixel values.

15. The method of claim 11, wherein the determining the estimated color temperature of the compressed video image or the color temperature of the decoded original video image and changing the color temperature of the decoded video image comprises:
determining the estimated color temperature of the compressed video image or the color temperature of the decoded original video image as the application color temperature according to whether the compressed video image is a moving video image; and
receiving the color temperature preferred by the user and changing the color temperature of the decoded original video image in accordance with the application color temperature and the color temperature preferred by the user.

16. The method of claim 15, wherein the determining the estimated color temperature of the compressed video image or the color temperature of the decoded original video image as the application color temperature comprises:
comparing a first color temperature difference between an estimated color temperature of the DC video image of a current frame and an estimated color temperature of the DC video image of a previous frame with a first predetermined critical value in response to the compressed video image being interframe coded; and
determining the application color temperature of the current frame by adding a correction function to the application color temperature of the previous frame in response to the first color temperature difference being smaller than the first critical value.

17. The method of claim 15, wherein the determining the estimated color temperature of the compressed video image or the color temperature of the decoded original video image as the application color temperature comprises:
comparing a first color temperature difference between an estimated color temperature of the DC video image of a current frame and an estimated color temperature of the DC video image of a previous frame with a first predetermined critical value in response to the compressed video image being interframe coded;
receiving the decoded current frame from the decoder, estimating the color temperature from the decoded current frame, calculating a second color temperature difference between the estimated color temperature of the DC video image of the current frame and the estimated color temperature of the decoded current frame, and comparing the second color temperature difference with a predetermined second critical value in response to the first color temperature difference being larger than the first critical value; and
determining the estimated color temperature of the DC video image of the current frame as the application color temperature of the current frame in response to the second color temperature difference being less than the second critical value.

18. The method of claim 15, wherein the determining the estimated color temperature of the compressed video image or the color temperature of the decoded original video image as the application color temperature comprises:
comparing a first color temperature difference between an estimated color temperature of the DC video image of a current frame and an estimated color temperature of the DC video image of a previous frame with a first predetermined critical value in response to the compressed video image being interframe coded;
receiving the decoded current frame from the decoder, estimating the color temperature from the decoded current frame, calculating a second color temperature difference between the estimated color temperature of the DC video image of the current frame and the estimated color temperature of the decoded current frame, and comparing the second color temperature difference with a predetermined second critical value in response to the first color temperature difference being larger than the first critical value; and
determining the estimated color temperature of the DC video image of the decoded current frame as the application color temperature of the current frame in response to the second color temperature difference being larger than the second critical value.

19. The method of claim 16, wherein the first color temperature difference between the estimated color temperature of the DC video image of the current frame and the estimated color temperature of the DC video image of the previous frame and the second color temperature difference between the estimated color temperature of the DC video image of the current frame and the estimated color temperature of the decoded current frame are differences between values obtained by multiplying inverse numbers of each color temperature by a predetermined coefficient.

20. The method of claim 16, wherein the first and second critical values are approximately 200° K.

21. A computer readable recording medium having recorded thereon the method off estimating and changing a color temperature of a compressed video image of claim 15.

22. The system of claim 7, wherein the first color temperature difference between the estimated color temperature of the DC video image of the current frame and the estimated color temperature of the DC video image of the previous frame and the second color temperature difference between the estimated color temperature of the DC video image of the current frame and the estimated color temperature of the decoded current frame are differences between values obtained by multiplying inverse numbers of each color temperature by a predetermined coefficient.

23. The system of claim 8, wherein the first color temperature difference between the estimated color temperature of the DC video image of the current frame and the estimated color temperature of the DC video image of the previous frame and the second color temperature difference between the estimated color temperature of the DC video image of the current frame and the estimated color temperature of the decoded current frame are differences between values obtained by multiplying inverse numbers of each color temperature by a predetermined coefficient.

24. The system of claim 7, wherein the first and second critical values are approximately 200 K.

25. The system of claim 8, wherein the first and second critical values are approximately 200 K.

26. The method of claim 17, wherein the first color temperature difference between the estimated color temperature of the DC video image of the current frame and the estimated color temperature of the DC video image of the previous frame and the second color temperature difference between the estimated color temperature of the DC video image of the current frame and the estimated color temperature of the decoded current frame are differences between values obtained by multiplying inverse numbers of each color temperature by a predetermined coefficient.

27. The method of claim 18, wherein the first color temperature difference between the estimated color temperature of the DC video image of the current frame and the estimated color temperature of the DC video image of the previous frame and the second color temperature difference between the estimated color temperature of the DC video image of the current frame and the estimated color temperature of the decoded current frame are differences between values obtained by multiplying inverse numbers of each color temperature by a predetermined coefficient.

28. The method of claim 17, wherein the first and second critical values are approximately 200 K.

29. The method of claim 18, wherein the first and second critical values are approximately 200 K.

30. A computer readable recording medium having recorded thereon the method of estimating and changing a color temperature of a compressed video image of claim 12.

31. A computer readable recording medium having recorded thereon the method of estimating and changing a color temperature of a compressed video image of claim 15.
